(19) United States
(12) Patent Application Publication
(10) Pub. No.: US 2011/0304910 A1
(43) Pub. Date: Dec. 15, 2011

(54) POLARIZATION CONVERSION DEVICE, POLARIZATION CONVERSION METHOD, AND DISPLAY APPARATUS

(75) Inventors: Tadashi Okano, Kanagawa (JP); Junichi Oshima, Kanagawa (JP)

(73) Assignee: SONY CORPORATION, Tokyo (JP)

(21) Appl. No.: 13/153,616

(22) Filed: Jun. 6, 2011

(30) Foreign Application Priority Data
Jun. 14, 2010 (JP) P2010-135613

(51) Int. Cl. G02B 27/26

(52) U.S. Cl. 359/465

(57) ABSTRACT

A polarization conversion device includes: a first polarization conversion unit that, on the basis of time-division display type stereoscopic image data including left images for left eye and right images for right eye, polarization-converts light beams of the left images and the right images output from a display unit that displays the left images and the right images and outputs polarized lights; a second polarization conversion unit that polarization-converts the polarized lights entering from the first polarization conversion unit and outputs polarized lights; and a control unit that controls times when the first and second polarization conversion units perform polarization conversion so that phase differences between the polarized lights of the left images and the right images may be inverted to each other at times when the left images and the right images are switched and displayed on the display unit.

### CROSS-REFERENCE TO RELATED APPLICATION

The present application claims priority from Japanese Patent Application No. JP 2010-135613 filed in the Japanese Patent Office on Jun. 14, 2010, the entire content of which is incorporated herein by reference.

### BACKGROUND OF THE INVENTION

1. Field of the Invention

The present invention relates to a polarization conversion device, a polarization conversion method, and a display apparatus suitable for application to the case where a user views spectroscopic images, for example.

2. Background Art

In related art, there is a technology of generating spectroscopic images (3D images) that a user can stereoscopically view using images of the same object imaged by two cameras placed according to disparity of right and left eyes of the user. The images imaged by the two cameras are referred to as a left image and a right image with respect to the eyes of the user (hereinafter, the left image and the right image are also collectively referred to as “right and left images”).

Further, there is a display apparatus by which the user can view images projected on a 3D display device or a screen as a display apparatus by which the user can view stereoscopic images. The display apparatus sequentially displays the polarization-converted right and left images, for example, and thus, viewers can view the stereoscopic images by wearing passive glasses (polarizing glasses).

Here, the technology of displaying the stereoscopic images used in related art will be explained.

As described above, the display device and the screen in related art display the right and left images alternatively on a picture area, and the user can view right and left images by wearing glasses with polarizers.

In Patent Document 1 (JP-A-2-48634) discloses a technology that allows a user to view the right and left images by providing respectively different circular polarizers in right and left lens parts of glasses.

### SUMMARY OF THE INVENTION

Images for one frame or one field are displayed by horizontal scanning. Accordingly, in a system of viewing stereoscopic images via polarizers in related art, definition of the images may become lower. This will be explained with reference to the following FIG. 13.

FIG. 13 shows an example of output phases of polarization conversion output from a stereoscopic image display apparatus 100 in related art.

The stereoscopic image display apparatus 100 includes a display unit 101 that displays right and left images and a polarization conversion unit 102 that polarizes light beams. The light beams output from the display unit 101 are right-handed polarized or left-handed polarized by the polarization conversion unit 102 and reach glasses (not shown).

Ideally, it is desirable that switching times between the phases of the right and left images output by the display unit 101 and the phases of the right and left images passing through the polarization conversion unit 102 coincide. However, in reality, with scanning of the right and left images, the right and left images are partially mixed at switching times of the right and left images. Accordingly, in the stereoscopic image display apparatus 100 of displaying the right and left images in a field/frame sequential manner and separating the right and left images by performing inverse-phase polarization conversion on the respective right and left images, if the response of the display unit 101 is poor, the right and left images are displayed with crosstalk. As a result, in the case where the display unit 101 displays images of an object moving quickly or the like, the definition of the images becomes lower due to the crosstalk occurring in the parts in which the phases of the right and left images are mixed.

Further, if the response of the polarization conversion unit 102 combined with the display unit 101 is poor, crosstalk occurs and the display unit 101 that can be combined is limited. Furthermore, in a system of providing shutters in the right and left lenses of glasses, the glasses become heavier.

Thus, it is desirable to reduce an influence of crosstalk of phases with switching of right and left images.

An embodiment of the invention is applicable in the case where, on the basis of time-division display type stereoscopic image data including left images for left eye and right images for right eye, a user visually recognizes light beams of the left images and the right images output from a display unit that displays the left images and the right images as stereoscopic images.

Further, a control unit controls times of polarization conversion of a first polarization conversion unit that performs polarization conversion and outputs polarized lights and a second polarization conversion unit that performs polarization conversion on the polarized lights entering from the first polarization conversion unit and outputs polarized lights.

In this regard, the control unit control the times of polarization conversion so that phase differences between polarized lights of the right and left images may be inverted.

In this manner, blacks with the inverted phase difference between the polarized lights of the right and left images may be inserted with switching times of the right and left images.

According to the embodiment of the invention, since blacks with the inverted phase difference between the polarized lights of the right and left images may be inserted with switching times of the right and left images, no crosstalk occurs in the periods. Accordingly, the visibility is improved when the user spectroscopically views the right and left images.

### BRIEF DESCRIPTION OF THE DRAWINGS

FIG. 1 is a configuration diagram showing a first configuration example of a stereoscopic image display system in a first embodiment of the invention.

FIG. 2 is a configuration diagram showing a second configuration example of the stereoscopic image display system in the first embodiment of the invention.

FIG. 3 is a block diagram showing an internal configuration example of a polarization conversion device in the first embodiment of the invention.

FIGS. 4A to 4D are explanatory diagrams showing a mechanism of linear polarization of the polarization conversion device in the first embodiment of the invention.

FIGS. 5A to 5D are model diagrams showing states of polarization of the polarization conversion device in the first embodiment of the invention.

FIG. 6 is an explanatory diagram showing an example of a timing chart of linear polarization in the first embodiment of the invention.

FIG. 7 is a block diagram showing an internal configuration example of a polarization conversion device in a second embodiment of the invention.

FIGS. 8A to 8D are explanatory diagrams showing a mechanism of circular polarization.

FIGS. 9A to 9D are model diagrams showing states of polarization of the polarization conversion device in the second embodiment of the invention.

FIG. 10 is an explanatory diagram showing an example of a timing chart of circular polarization in the second embodiment of the invention.

FIG. 11 is a block diagram showing an internal configuration example of a polarization conversion device in a third embodiment of the invention.

FIGS. 12A to 12D are model diagrams showing states of polarization of the polarization conversion device in the third embodiment of the invention.

FIG. 13 is an explanatory diagram showing an example of outputs of right and left images in related art.

### DESCRIPTION OF PREFERRED INVENTION

As below, the best mode of embodiments for implementing the invention (hereinafter, referred to as embodiments) will be explained. The explanation will be made in the following order.

1. First Embodiment (First polarization control: example provided with two polarizers)

2. Second Embodiment (Second polarization control: example provided with three polarizers)

3. Third Embodiment (Third polarization control: example provided with three polarizers)

4. Modified Examples

### 1. First Embodiment

[First Polarization Control: Example Provided with Two Polarizers]

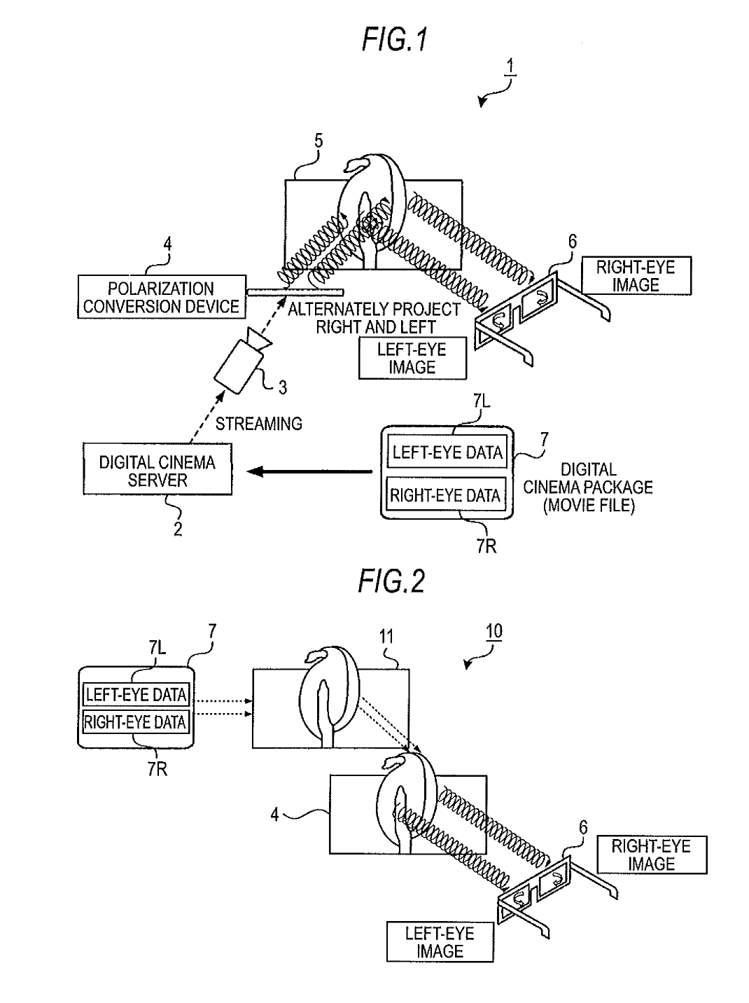

As below, the first embodiment of the invention will be explained with reference to FIGS. 1 to 6. In the embodiment, an example of application to a stereoscopic image display apparatus capable of displaying stereoscopic images, and a polarization conversion device and a polarization conversion method for polarization conversion at predetermined times will be explained.

FIG. 1 shows a configuration example of a stereoscopic image display system 1 of the example.

The stereoscopic image display system 1 has a configuration in which a polarization conversion device 4 that polarization-converts light beams is provided between a display unit 3 that projects right and left images and a silver screen 5.

The stereoscopic image display system 1 includes a digital cinema server 2 that loads left-eye data 7L and right-eye data 7R contained in an image file 7 with respect to each file and outputs image data of right and left images. Further, the stereoscopic image display system 1 includes the display unit 3 that projects stereoscopic images on the silver screen 5 under control of the digital cinema server 2 and the polarization conversion device 4 that is provided between the silver screen 5 and the display unit 3 and polarizes the projected images. Further, glasses 6 respectively have polarizers with different polarization directions in parts corresponding to the respective right and left lens parts.

For the image file 7, for example, a digital cinema package containing movie contents is used. The display unit 3 is a projector using a technology of DLP CINEMA (registered trademark), and alternatively projects the right and left images on the silver screen 5. Further, the light beams passing through the lens surfaces of the glasses 6 become circularly-polarized lights in different rotational directions between right and left. On the silver screen 5, the right and left images polarized by the polarization conversion device 4 are projected, and a user may view the right and left images entering the glasses 6 when the images are in the same direction as the polarization direction of the images projected on the silver screen 5. The glasses 6 are of passive type without the need of power supply or the like, and they may be reduced in weight and manufactured in the lower cost.

FIG. 2 shows a configuration example of a stereoscopic image display system 10 of the example.

In the stereoscopic image display system 10, the polarization conversion device 4 is provided between a display unit 11, which will be described later, and the glasses 6, and the detailed explanation of the parts to which the same signs as the signs according to the above explained stereoscopic image display system 1 will be omitted.

The display unit 11 displays right and left images from the input left-eye data 7L and right-eye data 7R. Further, the polarization conversion device 4 polarization-converts the light beams of the right and left images output by the display unit 11 at predetermined times. Accordingly, the right and left images separately enter the right and left lens parts of the glasses 6.

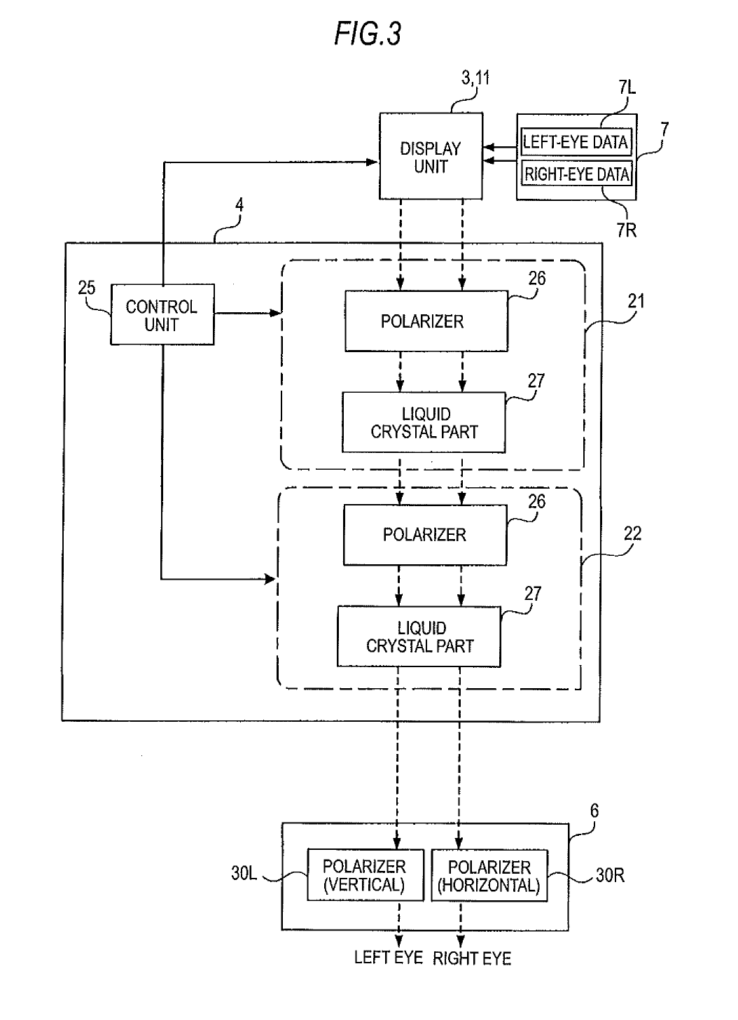

FIG. 3 shows an internal configuration example of the polarization conversion device 4.

The polarization conversion device 4 includes a first polarization conversion unit 21 that polarization-converts incident lights entering from the display units 3, 11 and outputs polarized lights and a second polarization conversion unit 22. The first polarization conversion unit 21 polarization-converts light beams of the left images and the right images output from the display unit that displays the left images and the right images based on time-division display type stereoscopic image data including left images for left eye and right images for right eye. The second polarization conversion unit 22 polarization-converts the polarized lights entering from the first polarization conversion unit 21 and outputs polarized lights. The first polarization conversion unit 21 and the second polarization conversion unit 22 are sequentially arranged in the incident direction of the light beams output by the display units 3, 11, and have polarizers 26 that output light beams in a direction in parallel to the transmission axis of the entering light beams. Further, they have liquid crystal parts 27 that hold the polarization directions of the light beams entering from the polarizers 26 when drive voltages from a control unit are turned off, and differentiate the phase difference between the light beams entering from the polarizers 26 by R and output linearly-polarized lights when the drive voltages from the control unit 25 are turned on.

Furthermore, the polarization conversion device 4 includes the control unit 25 that controls times when the first polarization conversion unit 21 and the second polarization conversion unit 22 modulate the incident lights. For the first polarization conversion unit 21 and the second polarization conversion unit 22, linear polarizers that output linearly-polarized lights are used. In this example, the display units 3, 11 and the polarization conversion device 4 are combined and used as a stereoscopic image display apparatus.

The glasses 6 include a polarizer 30L that allows the linearly-polarized light in the vertical direction to pass through and a polarizer 30R that allows the linearly-polarized light in the horizontal direction to pass through. Further, in the case where the directions of the polarizers of the polarization conversion device 4 are vertical and horizontal, the polarization directions are vertical and horizontal likewise in the polarizers 30L, 30R. Note that, in the case where the polarizers at the polarization conversion device 4 side are set in an oblique direction at a tilt of 45 degrees relative to the horizontal direction, the polarizers 30L, 30R of the glasses 6 are set at a tilt of 45 degrees likewise.

Next, an operation example of the polarization conversion device 4 will be explained.

First, the display units 3, 11 used in the stereoscopic image display systems 1, 10 display images from the input left-eye data 7L and right-eye data 7R. The times when the display units 3, 11 display images are controlled by the control unit 25. When the display units 3, 11 display images, light beams are output from the display surface, and the first polarization conversion unit 21 performs polarization conversion of differentiating the phase difference between the entering light beams by π and outputs linearly-polarized lights. Then, the linearly-polarized lights output by the first polarization conversion unit 21 enter the second polarization conversion unit 22, and the second polarization conversion unit 22 performs polarization conversion of differentiating the phase difference between the entering light beams by π and outputs linearly-polarized lights.

Here, the control unit 25 controls the switching times of the display units 3, 11 so that the left images and the right images may partially overlap at the switching times. Further, the control unit 25 differentiates the times when the first polarization conversion unit 21 and the second polarization conversion unit 22 perform polarization conversion. That is, the control unit 25 controls the times when the first and second polarization conversion units 21, 22 perform polarization conversion so that the phase differences between the polarized lights of the left images and the right images may be inverted. Accordingly, the linearly-polarized lights of the left images displayed from the left-eye data 7L and the right images displayed from the right-eye data 7R by the display units 3, 11 are alternately enter the glasses 6.

The linearly-polarized lights of the left images and the right images alternately enter the glasses 6. Here, the first polarization conversion unit 21 and the second polarization conversion unit 22 output the linearly-polarized lights with the switching times of the right and left images, and thus, the linearly-polarized lights of the right and left images alternately pass through the polarizers 30L, 30R. Accordingly, the user can recognize stereoscopic images.

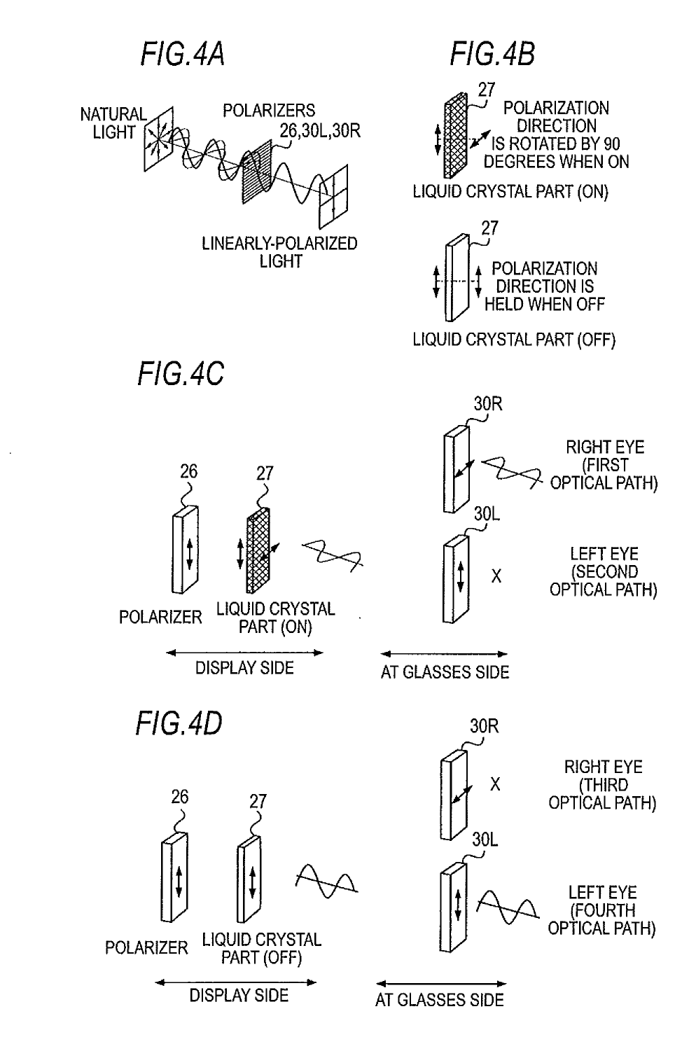

FIGS. 4A to 4D show a mechanism of polarization.

FIG. 4A shows an example of linear polarization.

Natural light contains light beams at various phases, and only the light beam having an amplitude direction within a fixed plane (in this example, the vertical direction) is allowed to pass through by the polarizers 26, 30L, 30R. The light beam that has passed through is linearly-polarized light.

FIG. 4B shows an example of a polarization direction when the drive voltage applied to the liquid crystal part 27 is turned on and off.

When the control unit 25 turns on the drive voltage applied to the liquid crystal part 27, the polarization direction of the liquid crystal part 27 rotates by 90 degrees. In this regard, the liquid crystal part 27 differentiates the phase difference between the light beams entering from the polarizer 26 by π and outputs linearly-polarized light. On the other hand, when the control unit 25 turns off the drive voltage applied to the liquid crystal part 27, the polarization direction of the liquid crystal part 27 is held.

In the following explanation, the case where the drive voltage is turned on for the liquid crystal parts 27 is discriminated by adding (ON) to the signs and the case where the drive voltage is turned off is discriminated by adding (OFF) to the signs.

FIGS. 4C and 4D show an example of combinations of the polarizers 26, 30R, 30L and the liquid crystal part 27.

Here, the side at which the polarization conversion device 4 is placed is referred to as “display side” and the side at which the polarizers are attached to the glasses 6 is referred to as “glasses side”. In FIG. 4C, the polarizer 26 and the liquid crystal part 27 are provided at the display side. Further, the “X” marks in the drawings represent that the light beam is not transmitted.

In this example, an optical path of the light beam passing through the polarizer 26, the liquid crystal part 27(ON), the polarizer 30R is referred to as “first optical path”. Further, an optical path of the light beam passing through the polarizer 26, the liquid crystal part 27(ON), the polarizer 30L is referred to as “second optical path”.

At the display side, the polarizer 26 and the liquid crystal part 27(ON) are provided. The light beam entering the polarizer 26 is input to the liquid crystal part 27 as linearly-polarized light and the liquid crystal part 27 rotates the polarization direction of the entering linearly-polarized light by 90 degrees and outputs the linearly-polarized light in the horizontal direction.

In the first optical path at the glasses side in which the light beam enters the right eye of the user, the polarizer 30R that transmits the linearly-polarized light in the horizontal direction is provided. On the other hand, in the second optical path at the glasses side in which the light beam enters the left eye of the user, the polarizer 30L that transmits the linearly-polarized light in the vertical direction is provided.

In the first optical path, the polarization direction of the linearly-polarized light that has been transmitted through the liquid crystal part 27 is in parallel to the polarization direction of the polarizer 30R, and thus, the linearly-polarized light passes through the polarizer 30R and the linearly-polarized light reaches the right eye of the user. Accordingly, the user may view the image with the right eye. On the other hand, in the second optical path, the polarization direction of the linearly-polarized light that has been transmitted through the liquid crystal part 27 is perpendicular to the polarization direction of the polarizer 30L, and thus, the linearly-polarized light does not pass through the polarizer 30L and the user may not view the image with the left eye.

Next, in this example, an optical path of the light beam passing through the polarizer 26, the liquid crystal part 27(OFF), the polarizer 30R is referred to as “third optical path”. Further, an optical path of the light beam passing through the polarizer 26, the liquid crystal part 27(OFF), the polarizer 30L is referred to as “fourth optical path”.

At the display side, the polarizer 26 and the liquid crystal part 27(OFF) are provided. The light beam entering the polarizer 26 is input to the liquid crystal part 27 as linearly-polarized light and the liquid crystal part 27 does not rotate the polarization direction of the entering linearly-polarized light and outputs the linearly-polarized light in the vertical direction.

In the third optical path, the polarization direction of the linearly-polarized light that has been transmitted through the liquid crystal part 27 is perpendicular to the polarization direction of the polarizer 30R, and thus, the linearly-polarized light does not pass through the polarizer 30R and the user may not view the image with the right eye. On the other hand, in the fourth optical path, the polarization direction of the linearly-polarized light that has been transmitted through the liquid crystal part 27 is in parallel to the polarization direction of the polarizer 30L, and thus, the linearly-polarized light passes through the polarizer 30L and the linearly-polarized light reaches the left eye of the user. Accordingly, the user may view the image with the left eye.

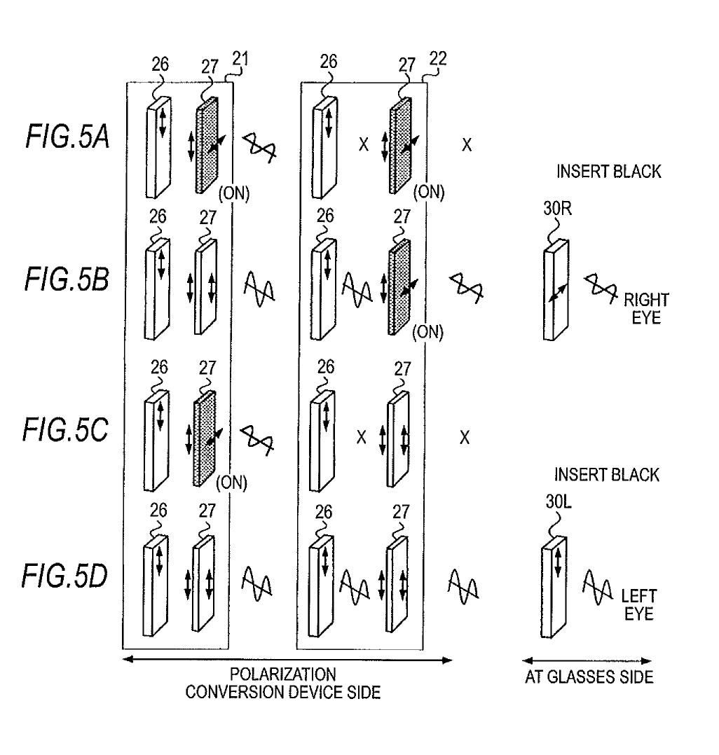

FIGS. 5A to 5D show states of polarization of the polarization conversion device 4 shown in FIGS. 4A to 4D.

As shown in FIG. 5A, the light beam polarization-converted by the polarizer 26 of the first polarization conversion unit 21 is linearly-polarized light and the liquid crystal part 27(ON) rotates the polarization direction of the linearly-polarized light by 90 degrees. The linearly-polarized light enters the polarizer 26 of the second polarization conversion unit 22. The polarization direction of the polarizer 26 is vertical, and the linearly-polarized light in the different polarization direction does not pass through it and no light beam enters the glasses 6. In this regard, with respect to the left eye of the user, the same effect as that of insertion of black is obtained.

As shown in FIG. 5B, the light beam polarization-converted by the polarizer 26 of the first polarization conversion unit 21 is the linearly-polarized light and the liquid crystal part 27(OFF) does not change the polarization direction of the linearly-polarized light and allows it pass through as it is. The linearly-polarized light enters the polarizer 26 of the second polarization conversion unit 22. The polarizer 26 does not change the polarization direction of the entering linearly-polarized light and allows it to pass through as it is and allows the linearly-polarized light to enter the liquid crystal part 27(ON) of the second polarization conversion unit 22. The liquid crystal part 27(ON) rotates the polarization direction of the entering linearly-polarized light by 90 degrees and outputs the light. The polarization direction of the polarizer 30R of the glasses is horizontal, and the glasses 6 output linearly-polarized light in parallel to the polarization direction of the polarizer 30R. The linearly-polarized light enters the right eye of the user as it is.

As shown in FIG. 5C, the light beam polarization-converted by the polarizer 26 of the first polarization conversion unit 21 is linearly-polarized light and the liquid crystal part 27(ON) rotates the polarization direction of the linearly-polarized light by 90 degrees. The linearly-polarized light enters the polarizer 26 of the second polarization conversion unit 22. The polarization direction of the polarizer 26 is vertical, and the linearly-polarized light in the different polarization direction does not pass through it and no light beam enters the glasses 6. In this regard, with respect to the right eye of the user, the same effect as that of insertion of black is obtained.

As shown in FIG. 5D, the light beam polarization-converted by the polarizer 26 of the first polarization conversion unit 21 is linearly-polarized light and the liquid crystal part 27(OFF) does not change the polarization direction of the linearly-polarized light and allows it to pass through as it is. The linearly-polarized light enters the polarizer 26 of the second polarization conversion unit 22. The polarizer 26 does not change the polarization direction of the entering linearly-polarized light and allows it to pass through as it is and allows the linearly-polarized light to enter the liquid crystal part 27(OFF) of the second polarization conversion unit 22. The liquid crystal part 27(OFF) rotates outputs the entering linearly-polarized light as it is. The polarization direction of the polarizer 30L of the glasses 6 is vertical, and the glasses 6 output linearly-polarized light in parallel to the polarization direction of the polarizer 30L. The linearly-polarized light enters the left eye of the user as it is.

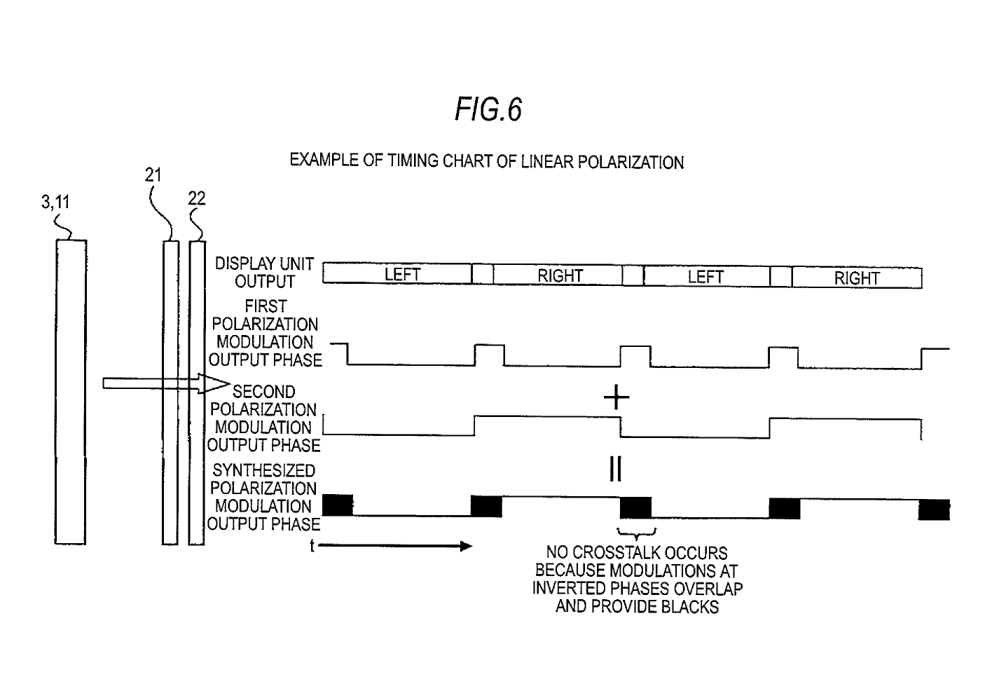

FIG. 6 shows an example of a timing chart in the case of linear polarization.

The display units 3, 11 alternately display the left images and the right images with respect to each frame. The timing chart shows that left images are output and right images are output when the phases of the linearly-polarized lights output by the first polarization conversion unit 21 and the second polarization conversion unit 22 are at L and H, respectively. Around the switching times of the right and left images, the phase difference between the phase of the linearly-polarized light modulated by the first polarization conversion unit 21 and the phase of the linearly-polarized light modulated by the second polarization conversion unit 22 is inverted by 180 degrees. Accordingly, in the parts in which the linearly-polarized lights at inverted phases overlap, blacks are inserted and no crosstalk occurs at switching of the right and left images.

According to the polarization conversion device 4 according to the above explained first embodiment, since the linearly-polarized lights modulated at the inverted phases with the switching times of the right and left images overlap, in the periods, they are recognized as blacks by the user. Accordingly, no crosstalk occurs in the right and left images, and there is an advantage that clear stereoscopic images are obtained.

Further, as application of display of stereoscopic images, by shifting the phases at the switching times of the right and left images of the first polarization conversion unit 21 and the second polarization conversion unit 22, blacks may be inserted into periods at the inverted phases corresponding to around the switching between right and left images. Furthermore, the control unit 25 can improve the crosstalk of the polarization conversion because the periods with poor response are black-muted by synthesizing the periods of black insertion with the periods at the switching times of the display units 3, 11. In this manner, crosstalk is improved by black insertion, and the visibility is improved when the user stereoscopically views right and left images.

### 2. Second Embodiment

[Second Polarization Control: Example Provided with Three Polarizers]

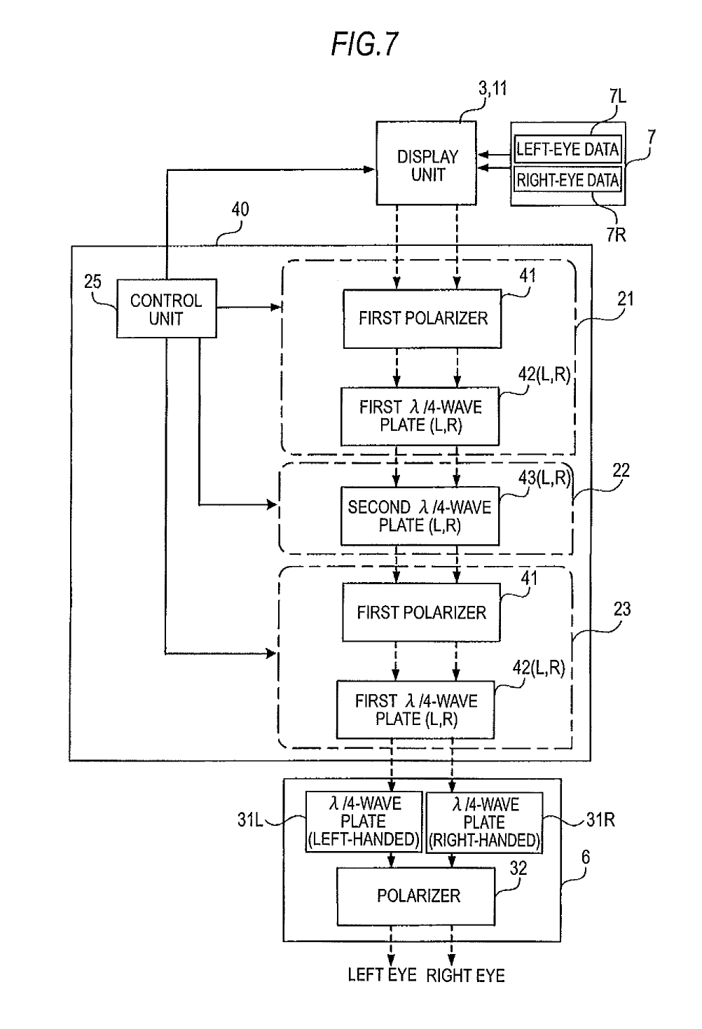

Next, a polarization conversion device 40 according to the second embodiment of the invention will be explained with reference to FIGS. 7 to 10.

In the following explanation, the same signs will be assigned to the parts corresponding to those in FIG. 3 that have already been explained in the first embodiment, and their detailed explanation will be omitted.

FIG. 7 shows an internal configuration example of the polarization conversion device 40.

The polarization conversion device 40 includes a third polarization conversion unit 23 that polarization-converts the polarized lights entering from the second polarization conversion unit 22 and outputs polarized lights in addition to the first polarization conversion unit 21 and the second polarization conversion unit 22. Further, the polarization conversion device 40 includes the control unit 25 that controls times when the first polarization conversion unit 21 to the third polarization conversion unit polarization-converts the incident lights. In this example, the display units 3, 11 and the polarization conversion device 40 are combined and used as a stereoscopic image display apparatus.

The first polarization conversion unit 21 to the third polarization conversion unit 23 is sequentially arranged in the incident direction of the light beams output by the display units 3, 11. Further, in the first polarization conversion unit 21 and the third polarization conversion unit 23, first polarizers 41 and first λ/4-wave plates 42 are sequentially arranged in the incident direction of the light beams output by the display units 3, 11. The second polarization conversion unit 22 provided between the first polarization conversion unit 21 and the third polarization conversion unit 23 has a second λ/4-wave plate 43 that differentiates the phase difference between the linearly-polarized lights by π/2 and outputs circularly-polarized lights.

The first polarization conversion unit 21 has the first polarizer 41 that performs polarization conversion by differentiating the phase difference between the entering light beams by π and outputs linearly-polarized lights.

Further, the first polarization conversion unit 21 includes the first λ/4-wave plate 42 that performs polarization conversion by differentiating the phase difference between the linearly-polarized lights by π/2, rotates the lights right-handed in the +45 degree direction or rotates the lights left-handed in the −45 degree direction, and outputs circularly-polarized lights.

The second polarization conversion unit 22 includes the second λ/4-wave plate 43 that performs polarization conversion by differentiating the phase difference between the circularly-polarized lights entering from the first polarization conversion unit 21 by π/2, rotates the lights right-handed in the +45 degree direction or rotates the lights left-handed in the −45 degree direction, and outputs circularly-polarized lights.

The third polarization conversion unit 23 has the first polarizer 41 that performs polarization conversion by differentiating the phase difference between the circularly-polarized lights entering from the second polarization conversion unit 22 by π and outputs linearly-polarized lights. Further, the third polarization conversion unit 23 includes the first λ/4-wave plate 42 that performs polarization conversion by differentiating the phase difference between the linearly-polarized lights by π/2, rotates the lights right-handed in the +45 degree direction or rotates the lights left-handed in the −45 degree direction, and outputs circularly-polarized lights.

The glasses 6 has polarizers 31L, 31R that the circularly-polarized lights output from the third polarization conversion unit 23 enter, polarization-convert the circularly-polarized lights, rotate the lights right-handed in the +45 degree direction or rotates the lights left-handed in the −45 degree direction, and outputs circularly-polarized lights. Further, the glasses 6 have a polarizer 32 that polarization-converts the circularly-polarized lights entering from the polarizers 31L, 31R and outputs linearly-polarized lights.

Next, an operation example of the polarization conversion device 40 will be explained.

First, the light beams output by the display units 3, 11 enter the first polarizer 41 of the first polarization conversion unit 21, are polarization-converted into linearly-polarized lights, and enter the first λ/4-wave plate 42. The circularly-polarized lights polarization-converted by the first λ/4-wave plate 42 enter the second λ/4-wave plate 43, are polarization-converted into circularly-polarized lights, and enter the first polarizer 41 of the third polarization conversion unit 23.

The linearly-polarized lights polarization-converted by the first polarizer 41 of the third polarization conversion unit 23 enter the first λ/4-wave plate 42, are polarization-converted into circularly-polarized lights, and enter the glasses 6. The polarizers 31L, 31R of the glasses 6 allow the polarization-converted circularly-polarized lights to enter the polarizer 32. The polarizer 32 polarization-converts the circularly-polarized lights into linearly-polarized lights and output the lights to the right and left eyes of the user. Thereby, the user can stereoscopically view the stereoscopic images.

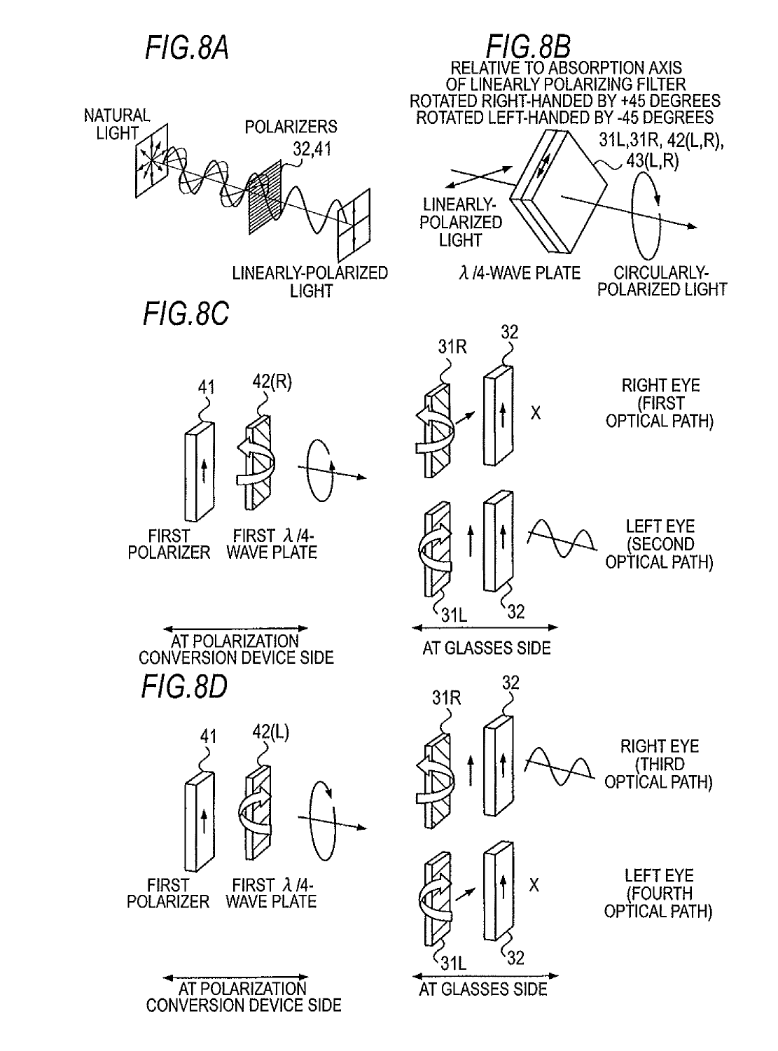

FIGS. 8A to 8D show a mechanism of polarization.

FIG. 8A shows an example of linear polarization.

Natural light contains light beams at various phases, and only the light beams having an amplitude direction within a fixed plane (in this example, the vertical direction) is allowed to pass through by the polarizers 32, 41. The light beam that has passed through is linearly-polarized light.

FIG. 8B shows an example of circular polarization.

The linearly-polarized lights that has passed through the polarizers 32, 41 in advance are polarization-converted by the λ/4-wave plates, and only the circularly-polarized light in the amplitude direction that draws a circle over time is allowed to pass through. The circularly-polarized light rotates right-handed when it is at +45 degrees relative to the absorption axis of the linearly-polarizing filter, and rotates left-handed at −45 degrees. In the following explanation, the case where the λ/4-wave plate performs right-handed polarization conversion is discriminated by adding (R) to the signs and the case where the λ/4-wave plate left-handed polarization conversion is discriminated by adding (L) to the signs.

FIG. 8C shows an example of a combination of the first polarizer 41 and the first λ/4-wave plate 42(L).

Here, the side at which the polarization conversion device 40 is placed is referred to as “display side” and the side at which the polarizer is attached to the glasses 6 is referred to as “glasses side”. In FIG. 8C, the first polarizer 41 and the first λ/4-wave plate 42(R) are provided at the display side. Further, the “X” marks in the drawings represent that the light beam is not transmitted.

In this example, an optical path of the light beam passing through the first polarizer 41, the first λ/4-wave plate 42(L), the polarizer 31L, and the polarizer 32 is referred to as “first optical path”. Further, an optical path of the light beam passing through the first polarizer 41, the first λ/4-wave plate 42(L), the polarizer 31R, and the polarizer 32 is referred to as “second optical path”.

At the display side, the first polarizer 41 and the first λ/4-wave plate 42(R) that rotates the light beam right-handed are provided. The light beam entering the first polarizer 41 is input to the first λ/4-wave plate 42(R) as linearly-polarized light and the first λ/4-wave plate 42(R) outputs circularly-polarized light rotating right-handed.

In the first optical path at the glasses side in which the light beam enters the right eye of the user, the polarizer 31R that rotates the light beam right-handed and the polarizer 32 are provided. On the other hand, in the second optical path at the glasses side in which the light beam enters the left eye of the user, the polarizer 31L that rotates the light beam left-handed and the polarizer 32 are provided.

In the first optical path, the circularly-polarized light tilts at 90 degrees (45 degrees+45 degrees) relative to the vertical direction of the polarizer 32, and thus, the circularly-polarized light does not pass through the polarizer 32 and the user may not view the image with the right eye. On the other hand, in the second optical path, the circularly-polarized light tilts back at 0 degrees (45 degrees−45 degrees) relative to the vertical direction, and thus, the circularly-polarized light passes through the first polarizer 41 and the linearly-polarized light reaches the left eye of the user. Accordingly, the user may view the image with the left eye.

FIG. 8D shows an example of the first polarizer 41 and the first λ/4-wave plate 42(L).

In this example, an optical path of the light beam passing through the first polarizer 41, the first λ/4-wave plate 42(L), the polarizer 31R, and the polarizer 32 is referred to as “third optical path”. Further, an optical path of the light beam passing through the first polarizer 41, the first λ/4-wave plate 42(L), the polarizer 31L, and the polarizer 32 is referred to as “fourth optical path”.

In the third optical path, the tilt relative to the vertical direction of the left-handed circularly-polarized light output by the first λ/4-wave plate 42(L) at the display side is back at 0 degrees by the polarizer 31R at the glasses side, and thus, the circularly-polarized light passes through the polarizer 32 and directly reaches the right eye of the user. Accordingly, the user may view the image with the right eye.

In the fourth optical path, the left-handed circularly-polarized light output by the first λ/4-wave plate 42(L) at the display side tilts at 90 degrees (45 degrees+45 degrees) relative to the vertical direction by the polarizer 31L at the glasses side, and thus, the circularly-polarized light may not pass through the polarizer 32. Accordingly, the user may not view the image with the left eye.

In this manner, by combining two polarizers and two λ/4-wave plates and performing polarization conversion of the λ/4-wave plate provided at the display side, the images reaching the right eye and the left eye of the user may be differentiated.

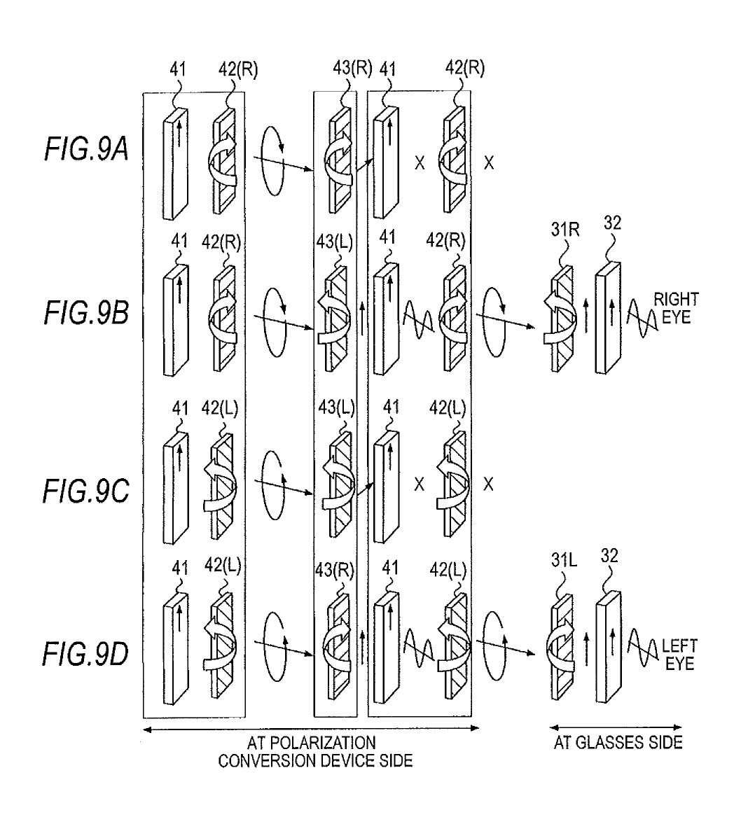

FIGS. 9A to 9D show states of polarization of the polarization conversion device 40 shown in FIG. 7.

As shown in FIG. 9A, the light beam polarization-converted by the first polarizer 41 of the first polarization conversion unit 21 is linearly-polarized light and the first λ/4-wave plate 42(R) polarization-converts the linearly-polarized light into circularly-polarized light. The circularly-polarized light rotates right-handed and enters the second λ/4-wave plate 43(R). The second λ/4-wave plate 43(R) polarization-converts the entering circularly-polarized light right-handed and outputs linearly-polarized light vertical to the polarization direction of the first polarizer 41 of the third polarization conversion unit 23. The linearly-polarized light is blocked by the first polarizer 41 and no light beam enters the glasses 6.

As shown in FIG. 9B, the light beam polarization-converted by the first polarizer 41 of the first polarization conversion unit 21 is linearly-polarized light and the first λ/4-wave plate 42(R) polarization-converts the linearly-polarized light into circularly-polarized light. The circularly-polarized light rotates right-handed and enters the second λ/4-wave plate 43(L). The second λ/4-wave plate 43(L) polarization-converts the entering circularly-polarized light left-handed and outputs linearly-polarized light in parallel to the polarization direction of the first polarizer 41 of the third polarization conversion unit 23. The first polarizer 41 allows the entering linearly-polarized light to pass through as it is, and the first λ/4-wave plate 42(R) polarization-converts the linearly-polarized light entering from the first polarizer 41 right-handed and outputs circularly-polarized light. Further, the polarizer 31R of the glasses 6 polarization-converts the entering circularly-polarized light right-handed and outputs linearly-polarized light in parallel to the polarization direction of the polarizer 32. The linearly-polarized light passes through the polarizer 32 as it is and enters the right eye of the user.

As shown in FIG. 9C, the light beam polarization-converted by the first polarizer 41 of the first polarization conversion unit 21 is linearly-polarized light and the first λ/4-wave plate 42(L) polarization-converts the linearly-polarized light into circularly-polarized light. The circularly-polarized light rotates left-handed and enters the second λ/4-wave plate 43(L). The second λ/4-wave plate 43(L) polarization-converts the entering circularly-polarized light left-handed and outputs linearly-polarized light vertical to the polarization direction of the first polarizer 41. The linearly-polarized light is blocked by the first polarizer 41 and no light beam enters the glasses 6.

As shown in FIG. 9D, the light beam polarization-converted by the first polarizer 41 of the first polarization conversion unit 21 is linearly-polarized light and the first λ/4-wave plate 42(L) polarization-converts the linearly-polarized light into circularly-polarized light. The circularly-polarized light rotates left-handed and enters the second λ/4-wave plate 43(R). The second λ/4-wave plate 43(R) polarization-converts the entering circularly-polarized light right-handed and outputs linearly-polarized light in parallel to the polarization direction of the first polarizer 41 of the third polarization conversion unit 23. The first polarizer 41 allows the entering linearly-polarized light to pass through as it is, and the first λ/4-wave plate 42(L) polarization-converts the linearly-polarized light entering from the first polarizer 41 left-handed and outputs circularly-polarized light. Further, the polarizer 31L of the glasses 6 polarization-converts the entering circularly-polarized light left-handed and outputs linearly-polarized light in parallel to the polarization direction of the polarizer 32. The linearly-polarized light passes through the polarizer 32 as it is and enters the left eye of the user.

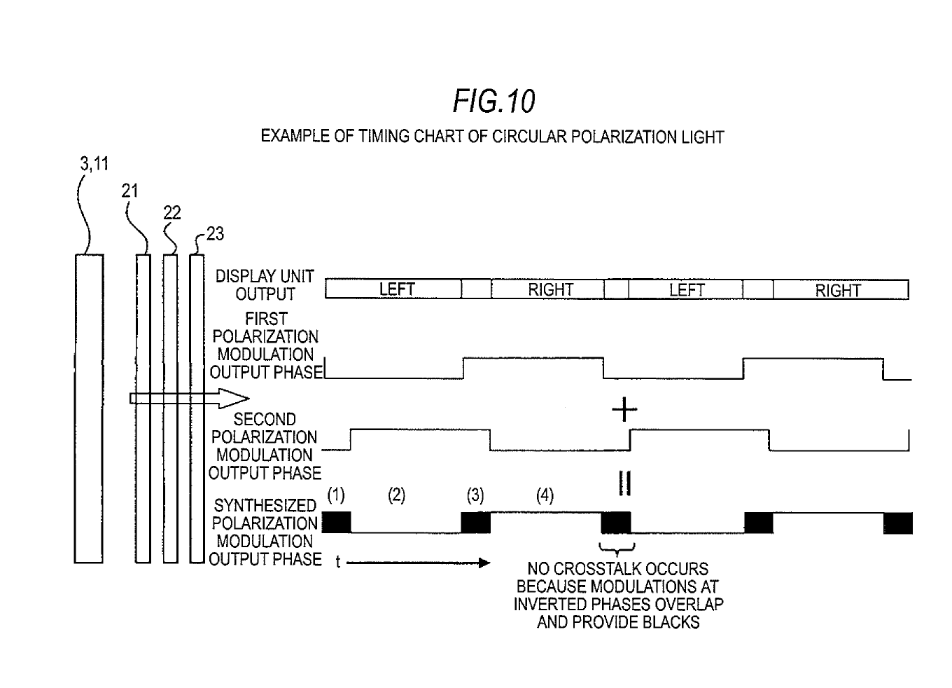

FIG. 10 shows an example of a timing chart in the case of circular polarization.

As described above, the polarization conversion device 40 includes the first polarization conversion unit 21 to the third polarization conversion unit 23 that transmit the light beams output by the display units 3, 11. In the timing chart, the output phase of the circularly-polarized lights output by the first polarization conversion unit 21 and the third polarization conversion unit 23 is shown at the top, the output phase of the circularly-polarized light output by the second polarization conversion unit 22 is shown in the middle. Further, the output phase of the polarized light synthesized by the first polarization conversion unit 21 to the third polarization conversion unit 23 is shown at the bottom. The phases of polarized lights show that left images are output and right images are output when the phases of the polarized lights are at L and H, respectively.

Here, the case where the display units 3, 11 alternately output the left images and the right images is assumed. For example, when the right images are displayed on the display units 3, 11, the left images are not displayed. However, in the middle of switching between outputs of the right and left images, the right and left images are gradually switched from the upper part of the display units 3, 11, and crosstalk occurs in related art. On the other hand, around the switching times of the right and left images, the phase difference between the phase of the linearly-polarized light modulated by the first polarization conversion unit 21 and the phase of the linearly-polarized light modulated by the second polarization conversion unit 22 is inverted by 180 degrees. Accordingly, in the parts in which the circularly-polarized lights at inverted phases overlap, blacks are inserted and no crosstalk occurs at switching of the right and left images.

According to the polarization conversion device 40 according to the above explained second embodiment, since the first polarization conversion unit 21 to the third polarization conversion unit 23 are provided, switching between right and left images may be performed better. Here, by superimposing two of the λ/4-wave plates that perform polarization conversion, modulation operation is performed at shifted times to provide phases inverted to each other around the switching between the right and left images. Further, both the first polarization conversion unit 21 and the third polarization conversion unit 23 have the first polarizers 41 and the first λ/4-wave plates 42 and the members may be used in common, and there is an advantage that the manufacturing cost may be reduced.

Further, in application other than display of stereoscopic images, a conversion method of polarized light using a polarization conversion device may be employed as one method of black insertion, and thus, the response of the apparent movement may be improved by inserting black with respect to each frame.

### 3. Third Embodiment

[Third Polarization Control: Example Provided with Three Polarizers]

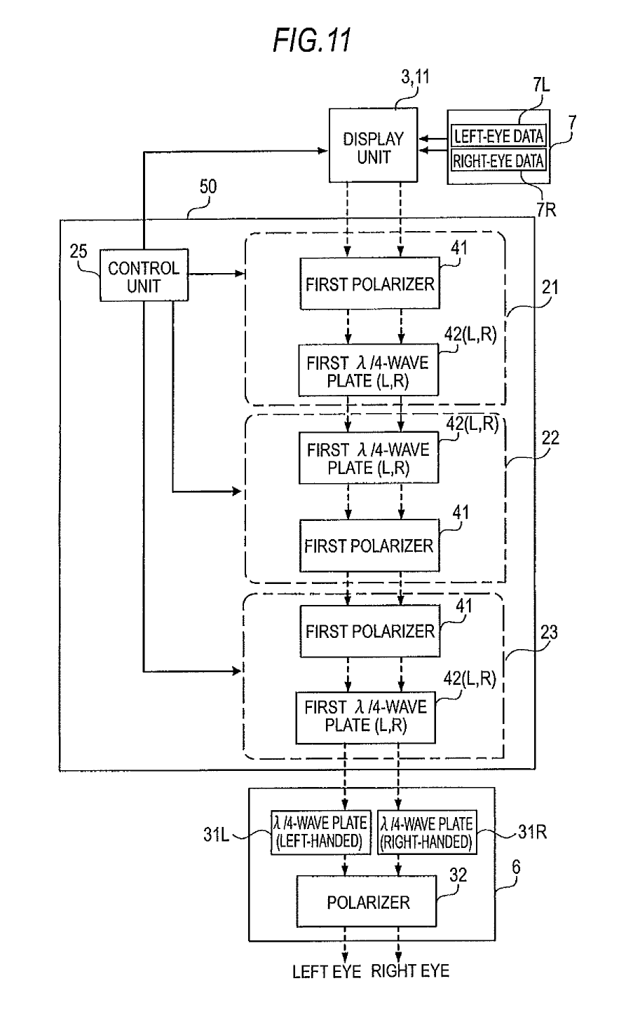

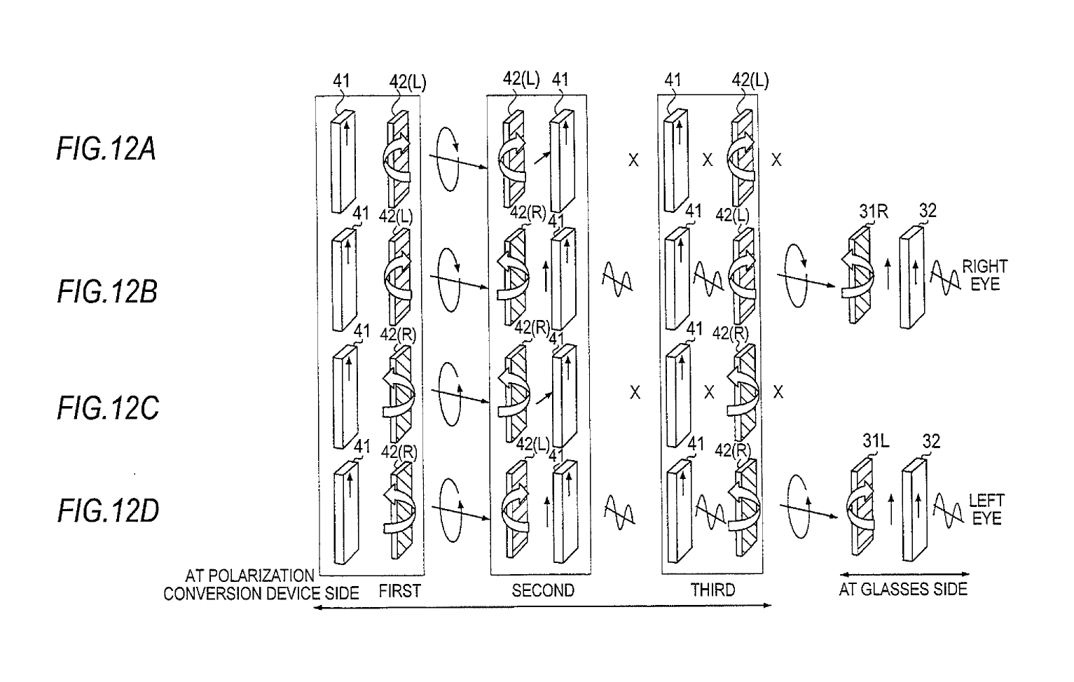

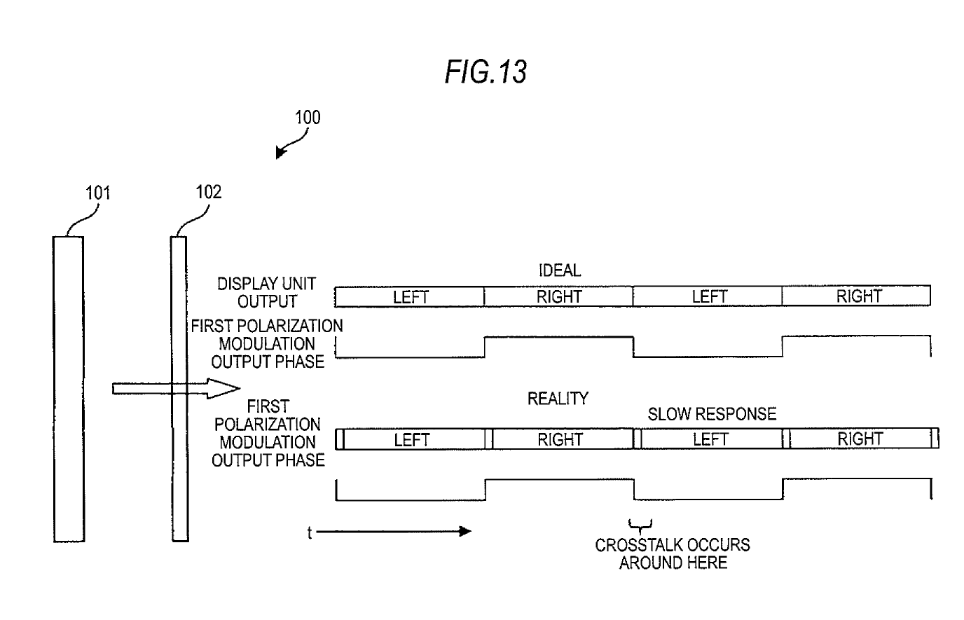

Next, a polarization conversion device according to the third embodiment of the invention will be explained with reference to FIGS. 11 and 12A to 12D.

In the following explanation, the same signs will be assigned to the parts corresponding to those in FIG. 7 that have already been explained in the second embodiment, and their detailed explanation will be omitted.

FIG. 11 shows an internal configuration example of the polarization conversion device 50.

The polarization conversion device 50 includes the first polarization conversion unit 21 that polarization-converts incident lights entering from the display units 3, 11 and outputs polarized lights, the second polarization conversion unit 22, and the third polarization conversion unit 23. Further, the polarization conversion device 50 includes the control unit 25 that controls times when the first polarization conversion unit 21 to the third polarization conversion unit 23 modulate the incident lights. In this example, the display units 3, 11 and the polarization conversion device 50 are combined and used as a stereoscopic image display apparatus.

The first polarization conversion unit 21 to the third polarization conversion unit 23 are sequentially arranged in the incident direction of the light beams output by the display units 3, 11. Further, the first polarization conversion unit 21 to the third polarization conversion unit include the first polarizers 41 that differentiate the phase differences between the respective entering light beams by π and output linearly-polarized lights and the first λ/4-wave plates 42 that differentiate the phase differences between the linearly-polarized lights by π/2 and output circularly-polarized lights.

In the first polarization conversion unit 21 and the third polarization conversion unit 23, the first polarizers and the first λ/4-wave plates 42 are sequentially arranged in the incident direction of the light beams output by the display units 3, 11. In the second polarization conversion unit 22, the first λ/4-wave plate 42 and the first polarizer 41 are sequentially arranged in the incident direction of the light beams output by the display units 3, 11. In this example, the second polarization conversion unit 22 is inserted on the reverse side between the first polarization conversion unit 21 and the third polarization conversion unit 23.

FIGS. 12A to 12D show states of polarization of the polarization conversion device 50 shown in FIG. 11.

As shown in FIG. 12A, the light beam polarization-converted by the first polarizer 41 of the first polarization conversion unit 21 is linearly-polarized light and the first λ/4-wave plate 42(L) polarization-converts the linearly-polarized light into circularly-polarized light. The circularly-polarized light rotates left-handed and enters the first λ/4-wave plate 42(L) of the second polarization conversion unit 22. The first λ/4-wave plate 42(L) polarization-converts the entering circularly-polarized light left-handed and outputs linearly-polarized light vertical to the polarization direction of the first polarizer 41. The linearly-polarized light is blocked by the first polarizer 41 of the third polarization conversion unit 23 and no light beam enters the glasses 6.

As shown in FIG. 12B, the light beam polarization-converted by the first polarizer 41 of the first polarization conversion unit 21 is linearly-polarized light and the first λ/4-wave plate 42(L) polarization-converts the linearly-polarized light into circularly-polarized light. The circularly-polarized light rotates left-handed and enters the first λ/4-wave plate 42(R) of the second polarization conversion unit 22. The first λ/4-wave plate 42(R) polarization-converts the entering circularly-polarized light right-handed and outputs linearly-polarized light in parallel to the polarization direction of the first polarizer 41 of the second polarization conversion unit 22. The first polarizer allows the entering linearly-polarized light to pass through as it is, and allows the light to enter the first polarizer 41 of the third polarization conversion unit 23. The first polarizer 41 of the third polarization conversion unit 23 allows the entering linearly-polarized light to pass through as it is and allows the light to enter the first λ/4-wave plate 42(L). The first λ/4-wave plate 42(L) polarization-converts the linearly-polarized light entering from the first polarizer 41 left-handed and outputs circularly-polarized light. Further, the polarizer 31R of the glasses 6 polarization-converts the entering circularly-polarized light right-handed and outputs linearly-polarized light in parallel to the polarization direction of the polarizer 32. The linearly-polarized light passes through the polarizer 32 as it is and enters the right eye of the user.

As shown in FIG. 12C, the light beam polarization-converted by the first polarizer 41 of the first polarization conversion unit 21 is linearly-polarized light and the first λ/4-wave plate 42(R) polarization-converts the linearly-polarized light into circularly-polarized light. The circularly-polarized light rotates right-handed and enters the first λ/4-wave plate 42(R) of the second polarization conversion unit 22. The first λ/4-wave plate 42(R) polarization-converts the entering circularly-polarized light right-handed and outputs linearly-polarized light vertical to the polarization direction of the first polarizer 41. The linearly-polarized light is blocked by the first polarizer 41 of the third polarization conversion unit 23 and no light beam enters the glasses 6.

As shown in FIG. 12D, the light beam polarization-converted by the first polarizer 41 of the first polarization conversion unit 21 is linearly-polarized light and the first λ/4-wave plate 42(R) polarization-converts the linearly-polarized light into circularly-polarized light. The circularly-polarized light rotates right-handed and enters the first λ/4-wave plate 42(L) of the second polarization conversion unit 22. The first λ/4-wave plate 42(L) polarization-converts the entering circularly-polarized light left-handed and outputs linearly-polarized light in parallel to the polarization direction of the first polarizer 41. The first polarizer 41 of the second polarization conversion unit allows the entering linearly-polarized light to pass through as it is, and allows the light to enter the first polarizer 41 of the third polarization conversion unit 23. The first polarizer 41 of the third polarization conversion unit 23 allows the entering linearly-polarized light to pass through as it is, and the first λ/4-wave plate 42(R) polarization-converts the linearly-polarized light entering from the first polarizer 41 right-handed and outputs circularly-polarized light. Further, the polarizer 31L of the glasses 6 polarization-converts the entering circularly-polarized light left-handed and outputs linearly-polarized light in parallel to the polarization direction of the polarizer 32. The linearly-polarized light passes through the polarizer 32 as it is and enters the left eye of the user.

According to the polarization conversion device 50 according to the above explained third embodiment, since the first polarization conversion unit 21 to the third polarization conversion unit 23 are provided, switching between right and left images may be performed better. Further, all of the first polarization conversion unit 21 to the third polarization conversion unit 23 have the first polarizers 41 and the members may be used in common. Accordingly, there is an advantage that the manufacturing cost may be reduced.

### 4. Modified Examples

In addition, when polarization conversion is performed by a combination of a display unit and the first polarization conversion unit 21 to the third polarization conversion unit 23, a display unit with slower movement may be combined by black insertion. Further, the circularly-polarized lights have been used in the above described embodiments, however, elliptically-polarized lights may be used.

It is obvious that the invention is not limited to the above described embodiments, and may take other various application examples and modified examples without departing from the scope of the invention described in claims.

What is claimed is:

1. A polarization conversion device comprising:
a first polarization conversion unit that, on the basis of time-division display type stereoscopic image data including left images for left eye and right images for right eye, polarization-converts light beams of the left images and the right images output from a display unit that displays the left images and the right images and outputs polarized lights;
a second polarization conversion unit that polarization-converts the polarized lights entering from the first polarization conversion unit and outputs polarized lights; and
a control unit that controls times when the first and second polarization conversion units perform polarization conversion so that phase differences between the polarized lights of the left images and the right images may be inverted to each other at times when the left images and the right images are switched and displayed on the display unit.

2. The polarization conversion device according to claim 1, wherein the first and second polarization conversion units are sequentially arranged in an incident direction of the light beams output by the display unit, and have polarizers that output light beams in a direction in parallel to a transmission axis of the entering light beams, and liquid crystal parts that hold the polarization directions of the light beams entering from the polarizers when drive voltages from the control unit are turned off, and differentiate phase differences between the light beams entering from the polarizers by π and output linearly-polarized lights when the drive voltages from the control unit are turned on.

3. The polarization conversion device according to claim 1, further comprising a third polarization conversion unit that polarization-converts the polarized lights entering from the second polarization conversion unit and outputs polarized lights,
wherein the control unit controls times when the first to third polarization conversion units perform polarization conversion.

4. The polarization conversion device according to claim 3, wherein the first to third polarization conversion units are sequentially arranged in an incident direction of the light beams output by the display unit, and have first polarizers that differentiate the phase differences between the entering light beams by π and output linearly-polarized lights, and first λ/4-wave plates that differentiate the phase differences between the linearly-polarized lights by π/2 and output circularly-polarized lights,
the first polarizers and the first λ/4-wave plates are sequentially arranged in the incident direction of the light beams output by the display unit in the first and third polarization conversion units, and
the second polarization conversion unit provided between the first polarization conversion unit and the third polarization conversion unit has a second λ/4-wave plate that differentiates the phase difference between the linearly-polarized lights by π/2 and outputs circularly-polarized lights.

5. The polarization conversion device according to claim 3, wherein the first to third polarization conversion units are sequentially arranged in an incident direction of the light beams output by the display unit, and have first polarizers that differentiate the phase difference between the entering light beams by π and output linearly-polarized lights, and first λ/4-wave plates that differentiate the phase differences between the linearly-polarized lights by π/2 and output circularly-polarized lights,
the first polarizers and the first λ/4-wave plates are sequentially arranged in the incident direction of the light beams output by the display unit in the first and third polarization conversion units, and
the first λ/4-wave plate and the first polarizer are sequentially arranged in the incident direction of the light beams output by the display unit in the second polarization conversion unit.

6. A polarization conversion method using
a first polarization conversion unit that, on the basis of time-division display type stereoscopic image data including left images for left eye and right images for right eye, polarization-converts light beams of the left images and the right images output from a display unit that displays the left images and the right images and outputs polarized lights and
a second polarization conversion unit that polarization-converts the polarized lights entering from the first polarization conversion unit and outputs polarized lights,
the method comprising the step of:
controlling times when the first and second polarization conversion units perform polarization conversion so that phase differences between the polarized lights of the left images and the right images may be inverted to each other at times when the left images and the right images are switched and displayed on the display unit.

7. A display apparatus comprising:
a display unit that, on the basis of time-division display type stereoscopic image data including left images for left eye and right images for right eye, displays the left images and the right images;
a first polarization conversion unit that polarization-converts light beams of the left images and the right images output from the display unit and outputs polarized lights;
a second polarization conversion unit that polarization-converts the polarized lights entering from the first polarization conversion unit and outputs polarized lights; and
a control unit that controls times when the first and second polarization conversion units perform polarization conversion so that phase differences between the polarized lights of the left images and the right images may be inverted to each other at times when the left images and the right images are switched and displayed on the display units.
